(19) United States
(12) Patent Application Publication
(10) Pub. No.: US 2026/0004695 A1
(43) Pub. Date: Jan. 1, 2026

(54) METHOD OF CONVERTING COLOR GAMUT AND DISPLAY DEVICE FOR PERFORMING THE SAME

(71) Applicant: Samsung Display Co., Ltd., Yongin-si (KR)

(72) Inventors: Hyun Kyung SONG, Yongin-si (KR); Ji Eun JANG, Yongin-si (KR); Won Bok LEE, Yongin-si (KR); Jong Woong PARK, Yongin-si (KR)

(21) Appl. No.: 19/209,453

(22) Filed: May 15, 2025

(30) Foreign Application Priority Data
Jun. 26, 2024 (KR) 10-2024-0083923

(51) Int. Cl. G09G 3/20

(52) U.S. Cl. CPC G09G 3/2003; G09G 2320/0242; G09G 2320/0285; G09G 2340/06

(57) ABSTRACT

A method of converting a color gamut includes generating first color gamut conversion lookup tables for gradations, applying each of the first color gamut conversion lookup tables to a red-green-blue (RGB) value of a comparison pattern to generate a compensation RGB value for each of the first color gamut conversion lookup tables, determining an expected luminance according to the compensation RGB value, comparing the expected luminance with a target luminance in the comparison pattern, selecting at least one of the first color gamut conversion lookup tables as a second color gamut conversion lookup table according to a comparison result, and converting the color gamut of an image displayed on a display panel using the second color gamut conversion lookup table.

### CROSS-REFERENCE TO RELATED APPLICATION

The present application claims priority to and the benefit of Korean Patent Application No. 10-2024-0083923, filed on Jun. 26, 2024, in the Korean Intellectual Property Office, the entire disclosure of which is incorporated by reference herein.

### BACKGROUND

### 1. Field

The present disclosure relates to a method of converting a color gamut and a display device for performing the same. Specifically, the present disclosure relates to a method of converting a color gamut an image displayed on a display device, and a display device for performing the same.

### 2. Description of the Related Art

Generally, in order for a display device to display an image generated by a digital camera and/or camcorder, a target color gamut of an image (for example, a standard red-green-blue (sRGB) color gamut may be a native color gamut of a display device. However, because there are various types of color gamuts usable for image display, and each manufacturer uses different color gamuts for various reasons, a display device may perform color gamut conversion on image data to display a certain image in accurate colors.

### SUMMARY

Aspects and features of embodiments of the present disclosure are to provide a method of converting a color gamut, which converts a color gamut in consideration of luminance.

Another aspect of the present disclosure is to provide a display device for performing a method of converting a color gamut.

In order to achieve one or more aspects of the present disclosure, a method of converting a color gamut according to one or more embodiments of the present disclosure includes generating first color gamut conversion lookup tables for gradations, applying each of the first color gamut conversion lookup tables to a red-green-blue (RGB) value of a comparison pattern to generate a compensation RGB value for each of the first color gamut conversion lookup tables, determining an expected luminance according to the compensation RGB value, comparing the expected luminance with a target luminance in the comparison pattern, selecting at least one of the first color gamut conversion lookup tables as a second color gamut conversion lookup table according to a comparison result, and converting the color gamut of an image displayed on a display panel using the second color gamut conversion lookup table.

In one or more embodiments, a lookup table with a smallest difference between the expected luminance and the target luminance from among the first color gamut conversion lookup tables may be selected as the second color gamut conversion lookup table.

In one or more embodiments, the comparison pattern may include at least one of patterns of a Macbeth chart.

In one or more embodiments, the determining of the expected luminance may include converting the compensation RGB value into a tristimulus XYZ value using an RGB2XYZ conversion matrix, and determining the expected luminance from the tristimulus XYZ value for the compensation RGB value.

In one or more embodiments, the target luminance may be preset.

In one or more embodiments, the generating of the first color gamut conversion lookup tables may include converting target color coordinates of a measurement pattern for one gradation to a target RGB value using an RGB2XYZ conversion matrix, and generating the first color gamut conversion lookup table for the one gradation by allowing the RGB value of the measurement pattern to correspond to the target RGB value.

In one or more embodiments, the comparison pattern may be different from the measurement pattern.

In one or more embodiments, the generating of the first color gamut conversion lookup tables further may include displaying a white pattern on the display panel, and measuring color coordinates of the display panel, wherein a reference white point of the RGB2XYZ conversion matrix is determined by the color coordinates of the display panel in the white pattern.

In one or more embodiments, the measurement pattern may be at least one of a white pattern, a red pattern, a green pattern, a blue pattern, a cyan pattern, a magenta pattern, or a yellow pattern.

In one or more embodiments, each of the first color gamut conversion lookup tables may include RGB values of grid points defining the converted color gamut.

In order to achieve another object of the present disclosure, a display device according to one or more embodiments of the present disclosure includes a display panel including a pixel, a data driver configured to provide a data voltage to the pixel, and a driving controller configured to control the data driver.

The driving controller is configured to: apply each of first color gamut conversion lookup tables to an red-green-blue (RGB) value of a comparison pattern to generate a compensation RGB value for each of the first color gamut conversion lookup tables, determine an expected luminance according to the compensation RGB value, compare an expected luminance with target luminance in the comparison pattern, select at least one of the first color gamut conversion lookup tables as a second color gamut conversion lookup table according to a comparison result, and convert a color gamut of an image displayed on the display panel using the second color gamut conversion lookup table.

In one or more embodiments, the driving controller may be configured to select a lookup table with a smallest difference between the expected luminance and the target luminance from among the first color gamut conversion lookup tables as the second color gamut conversion lookup table.

In one or more embodiments, the comparison pattern may include at least one of patterns of a Macbeth chart.

In one or more embodiments, the driving controller may be configured to convert the compensation RGB value into a tristimulus XYZ value using an RGB2XYZ conversion matrix and may be configured to determine the expected luminance from a tristimulus value for the compensation RGB value.

In one or more embodiments, the target luminance may be preset.

In one or more embodiments, the display device may further include a memory device configured to store the first color gamut conversion lookup tables.

In one or more embodiments, each of the first color gamut conversion lookup tables may include RGB values of grid points defining the converted color gamut.

In one or more embodiments, an electronic device includes: a display panel including a pixel; a data driver configured to provide a data voltage to the pixel; a driving controller configured to control the data driver; a processor configured to provide input image data to the driving controller, wherein the driving controller is configured to: apply each of first color gamut conversion lookup tables to an red-green-blue (RGB) value of a comparison pattern to generate a compensation RGB value for each of the first color gamut conversion lookup tables; determine an expected luminance according to the compensation RGB value; compare the expected luminance with a target luminance in the comparison pattern; select at least one of the first color gamut conversion lookup tables as a second color gamut conversion lookup table according to a comparison result; and convert a color gamut of an image displayed on the display panel using the second color gamut conversion lookup table, wherein the target luminance is preset.

In one or more embodiments, the electronic device includes a digital television (TV), a three-dimensional (3D) TV, a mobile phone, a smartphone, a tablet computer, a virtual reality (VR) device, a home electronic device, a laptop computer, a personal digital assistant (PDA), a portable media player (PMP), a digital camera, a music player, a portable game console, or a navigation device.

A display device according to one or more embodiments of the present disclosure, by comparing expected luminance with a target luminance and performing color gamut conversion using a selected lookup table, a color to be displayed can be displayed accurately.

However, the effects, aspects, and features of the present disclosure are not limited to the above, and within the scope not exceeding the idea and the field of the present disclosure, various expansions may be made.

### BRIEF DESCRIPTION OF THE DRAWINGS

FIG. 1 is a flowchart illustrating a method of converting a color gamut according to one or more embodiments of the present disclosure.

FIG. 2 is a flowchart illustrating operation S100 of the method of converting a color gamut of FIG. 1.

FIG. 3 is a diagram illustrating an example in which a first color gamut conversion lookup table according to the method of converting a color gamut of FIG. 1 is generated.

FIG. 4 is a diagram illustrating an example of a first color gamut conversion lookup table according to the method of converting a color gamut of FIG. 1.

FIG. 5 is a conceptual diagram illustrating a change in color gamut when the first color gamut conversion lookup table of FIG. 4 is applied.

FIG. 6 is a conceptual diagram showing an example in which expected luminance according to the method of converting a color gamut of FIG. 1 is determined.

FIG. 7 is a conceptual graph showing an example in which a second color gamut conversion lookup table according to the method of converting a color gamut of FIG. 1 is selected.

FIGS. 8 and 9 are diagrams showing color difference improvement according to the method of converting a color gamut of FIG. 1.

FIG. 10 is a block diagram illustrating a display device according to one or more embodiments of the present disclosure.

FIG. 11 is a block diagram illustrating a display device according to one or more embodiments of the present disclosure.

FIG. 12 is a block diagram illustrating an example of a driving controller of FIG. 11.

FIG. 13 is a block diagram illustrating an electronic device according to one or more embodiments of the present disclosure.

FIG. 14 is a view illustrating an example in which the electronic device of FIG. 13 is implemented as a smartphone.

### DETAILED DESCRIPTION

Hereinafter, embodiments according to the present disclosure will be described in detail with reference to the attached drawings. In the following description, it should be noted that only portions required for comprehension of operations according to the present disclosure will be described and descriptions of other portions will be omitted not to make subject matters of the present disclosure obscure. In addition, the present disclosure is not limited to the following described embodiments but may also be embodied in other forms. Rather, these embodiments are provided so that the present disclosure will be thorough, and complete, and will fully convey the present disclosure to those skilled in the art.

Throughout the specification, it will be understood that when an element is referred to as being “coupled” or “connected” to another element, it can be directly coupled or connected to the other element or intervening elements may be present therebetween. The terminology used herein is for the purpose of describing specific embodiments and is not intended to limit the present disclosure. Throughout the specification, unless explicitly described to the contrary, the word “comprise” and variations such as “comprises” or “comprising” will be understood to imply the inclusion of stated elements but not the exclusion of any other elements. “At least any one of X, Y, and Z” and “at least any one selected from the group consisting of X, Y, and Z” may be construed as each of X, Y, and Z or a combination of two or more of X, Y, and Z (for example, XYZ, XYY, YZ, and ZZ). As used herein, “and/or” includes one or more combinations of corresponding components.

It will be understood that, although the terms “first,” “second,” “third,” and so on may be used herein to describe various elements, these elements are not limited by these terms. These terms are used to distinguish one element from another element. Thus, a first element described below could also be termed as a second or third element without departing from the spirit and scope of the present disclosure.

Spatially relative terms, such as “beneath,” “below,” “lower,” “above,” “upper,” and/or the like, may be used herein for descriptive purposes, and, thereby, to describe one element or feature's relationship to another element(s) or feature(s) as shown in the drawings. Spatially relative terms are intended to encompass different orientations of a device in use, operation, and/or manufacture in addition to the orientation depicted in the drawings. For example, if the device in the drawings is turned over, elements described as “below” or “beneath” other elements or features would then be oriented “above” the other elements or features. Thus, in one or more embodiments, the term “below” can encompass both an orientation of above and below. directions. Furthermore, the device may be otherwise oriented (e.g., rotated 90 degrees or at other orientations), and, as such, the spatially relative descriptors used herein interpreted accordingly.

Various embodiments are described with reference to drawings that schematically illustrate ideal embodiments. Accordingly, it will be expected that the shapes may vary depending, for example, on tolerances and/or manufacturing techniques. Accordingly, embodiments disclosed herein should not be construed as limited to the specific shapes shown herein, but should be construed to include deviations in shapes that result from, for instance, manufacturing. As such, the shapes shown in the drawings may not depict the actual shapes of regions of the device, and the present embodiments are not limited thereto.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

Hereinafter, the present disclosure will be described in more detail with reference to the accompanying drawings.

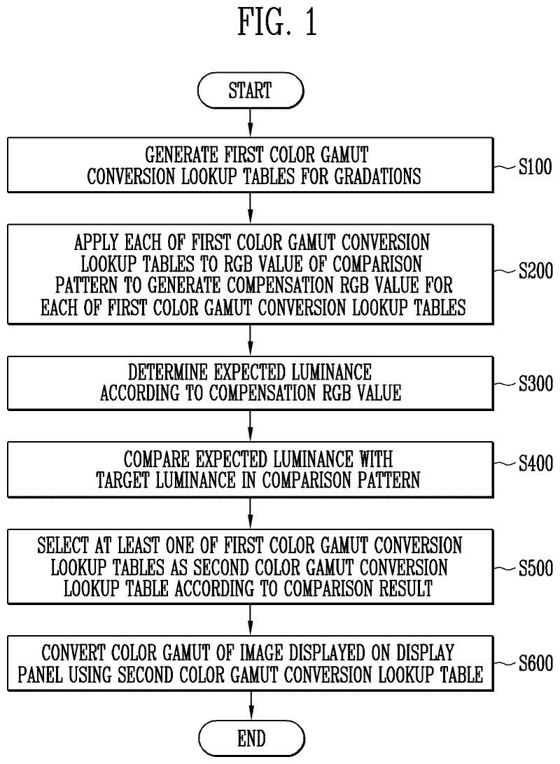

FIG. 1 is a flowchart illustrating a method of converting a color gamut according to one or more embodiments of the present disclosure.

Referring to FIG. 1, in the method of converting a color gamut, first color gamut conversion lookup tables for gradations may be generated (S100), each of the first color gamut conversion lookup tables may be applied to a red-green-blue (RGB) value of a comparison pattern to generate a compensation RGB value for each of the first color gamut conversion lookup tables (S200), expected luminance according to a compensation RGB value may be determined (S300), the expected luminance may be compared with target luminance in the comparison pattern (S400), at least one of the first color gamut conversion lookup tables may be selected as a second color gamut conversion lookup table according to a comparison result (S500), and a color gamut of an image displayed on a display panel may be converted using the second color gamut conversion lookup table (S600).

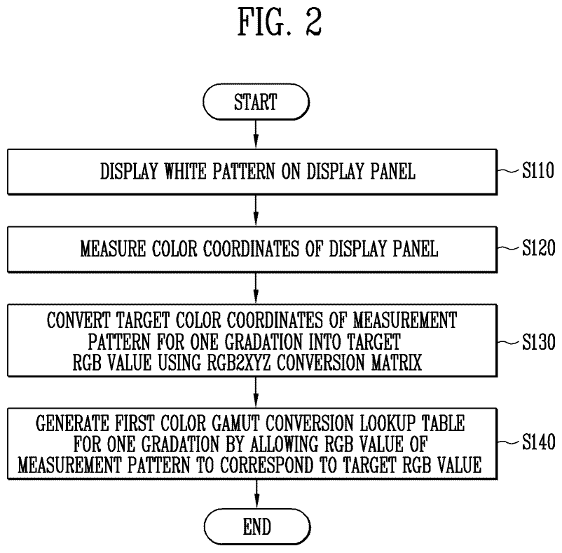

Hereinafter, the method will be described in detail with reference to FIGS. 2-13.

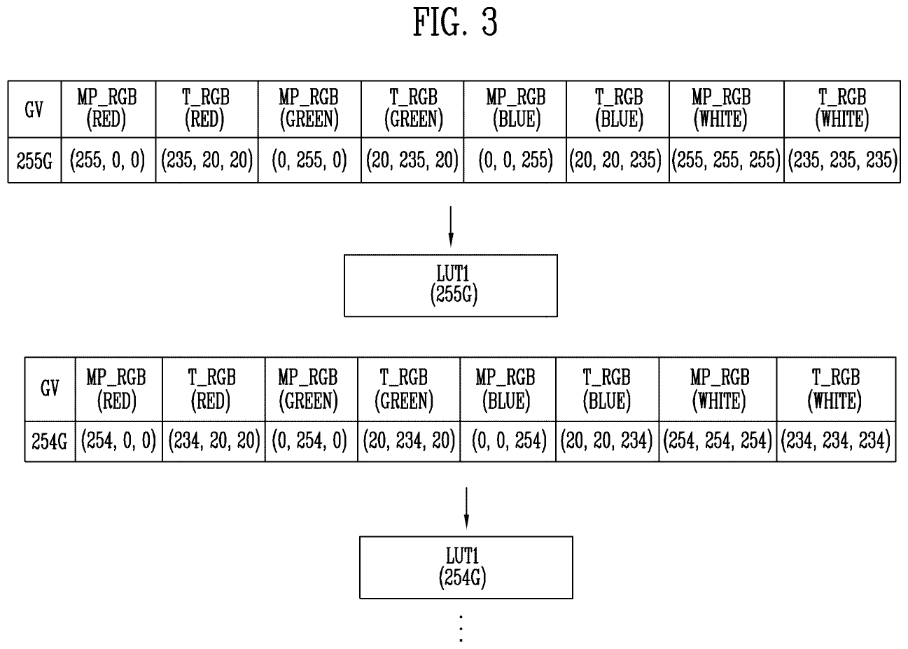

FIG. 2 is a flowchart illustrating operation S100 of the method of converting a color gamut of FIG. 1. FIG. 3 is a diagram illustrating an example in which the first color gamut conversion lookup table according to the method of converting a color gamut of FIG. 1 is generated.

For convenience of description, an RGB value in FIG. 3 is expressed in the form of (q, w, e). Here, q is an R value of the RGB value, w is a G value of the RGB value, and e is a B value of the RGB value. This also applies to the drawings below.

Referring to FIG. 2, in the method of converting a color gamut, the first color gamut conversion lookup tables for gradations may be generated. In the method of converting a color gamut, a white pattern may be displayed on the display panel (S110), color coordinates of the display panel may be measured (S120), target color coordinates of a measurement pattern for one gradation may be converted into a target RGB value using an RGB2XYZ conversion matrix (S130), and the first color gamut conversion lookup table for one gradation may be generated by allowing an RGB value of the measurement pattern to correspond to the target RGB value (S140).

Specifically, in the method of converting a color gamut, the white pattern may be displayed on the display panel (S110). Here, the white pattern refers to a pattern having an RGB value in which an R value, a G value, and a B value are the same. For example, the white pattern used in operation S110 may be a white pattern with a 255-gradation (that is, a pattern in which an RGB value is (255, 255, 255)). However, the present disclosure is not limited to the gradation of the white pattern used in operation S110.

Specifically, in the method of converting a color gamut, the color coordinates of the display panel may be measured (S120). The color coordinates may be measured using an imaging device. For example, the imaging device may be a camera, sensor, and/or the like.

Accordingly, color coordinates of the white pattern of the display panel may be measured. The measured color coordinates may become a reference white point for generating the RGB2XYZ conversion matrix. The RGB2XYZ conversion matrix is a matrix for converting an RGB value into a tristimulus XYZ value and requires a reference point (for example, a reference white point). By using the color coordinates of the display panel as the reference white point, the characteristics of the display panel may be reflected in the RGB2XYZ conversion matrix. Here, the RGB2XYZ conversion matrix refers to a matrix that converts an RGB value into a tristimulus XYZ value.

In one or more embodiments, color coordinates in a red pattern, color coordinates in a green pattern, color coordinates in a blue pattern, color coordinates in a cyan pattern, color coordinates in a magenta pattern, and/or color coordinates in a yellow pattern in the display pattern may be used as a reference point for the RGB2XYZ conversion matrix. In one or more embodiments, one of CIE (International Commission on Illumination) standard light sources may be used as a reference point for the RGB2XYZ conversion matrix. However, the present disclosure is not limited to the reference point for the RGB2XYZ conversion matrix.

Here, the red pattern refers to a pattern having an RGB value in which a G value and a B value other than an R value have a value of 0, the green pattern refers to a pattern having an RGB value in which an R value and a B value other than a G value have a value of 0, a blue pattern refers to a pattern having an RGB value in which an R value and a G value other than a B value have a value of 0, the cyan pattern refers to a pattern having an RGB value in which a G value and a B value have the same value and an R value has a value of 0, the magenta pattern refers to a pattern having an RGB value in which an R value and a B value have the same value and a G value has a value of 0, and the yellow pattern refers to a pattern having an RGB value in which an R value and a G value have the same value and a B value has a value of 0.

Referring to FIGS. 2 and 3, in the method of converting a color gamut, target color coordinates of a measurement pattern for one gradation GV may be converted into a target RGB value T_RGB using the RGB2XYZ conversion matrix, and a first color gamut conversion lookup table LUT1 for the gradation GV may be generated by allowing an RGB value MP_RGB of the measurement pattern to correspond to the target RGB value T_RGB.

The RGB value MP_RGB of the measurement pattern is a value that is automatically determined when the measurement pattern is determined (e.g., the RGB value MP_RGB of the measurement pattern is a suitable value). For example, when the measurement pattern is a red pattern RED, an RGB value of the red pattern RED for 255-gradation 255G may be (255, 0, 0).

The measurement pattern may be at least one of a white pattern WHITE, a red pattern RED, a green pattern GREEN, a blue pattern BLUE, a cyan pattern, a magenta pattern, or a yellow pattern.

Although the red pattern RED, the green pattern GREEN, the blue pattern BLUE, and the white pattern WHITE are illustrated in FIG. 3 as being used as measurement patterns, the present disclosure is not limited to types of the measurement patterns.

The target color coordinates of the measurement pattern may be color coordinates desired to be displayed on the display panel when the measurement pattern is displayed on the display panel. The target color coordinates may be preset. The target color coordinates may be expressed as a tristimulus XYZ value.

Because the target color coordinates are expressed as the tristimulus XYZ value, the target RGB value T_RGB may be generated by applying an inverse matrix of the RGB2XYZ conversion matrix to the target color coordinates.

The first color gamut conversion lookup table LUT1 may be generated by allowing the RGB value MP_RGB of the measurement pattern to correspond to the target RGB value T_RGB. For example, when the RGB value MP_RGB of the measurement pattern is (255, 0, 0) and the corresponding target RGB value T_RGB is (235, 20, 20), an RGB value of (255, 0, 0) may be converted into an RGB value of (235, 20, 20) using the first color gamut conversion lookup table LUT1.

In one or more embodiments, RGB values other than the measurement pattern may be converted through interpolation. However, the present disclosure is not limited to a method of determining RGB values other than the measurement pattern.

Operations S130 and S140 may be performed to generate the first color gamut conversion lookup table LUT1 for one gradation GV. Then, operations S130 and S140 may be repeated to generate the first color gamut conversion lookup table LUT1 for all gradations GV. However, in the present disclosure, it is not necessary to generate the first gamut conversion lookup table LUT1 for all gradations GV, but it is possible to generate the first color gamut conversion lookup table LUT1 for some representative gradations GV.

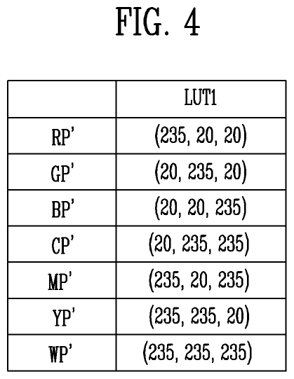

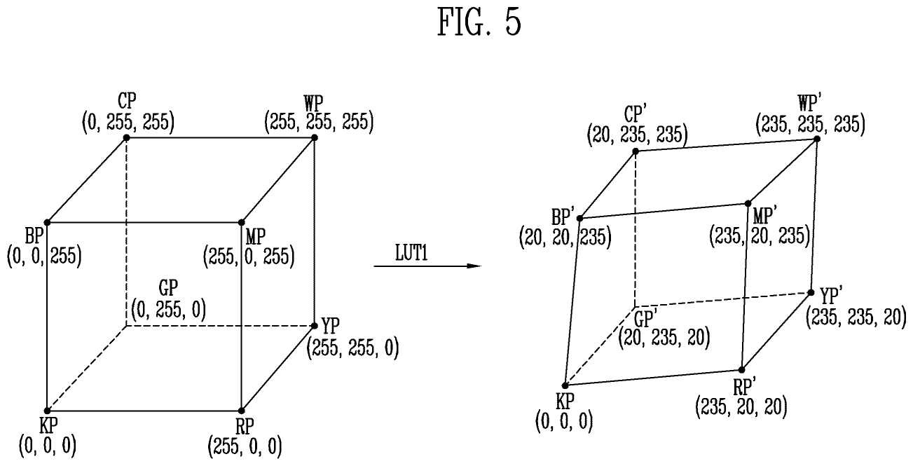

FIG. 4 is a diagram illustrating an example of a first color gamut conversion lookup table according to the method of converting a color gamut of FIG. 1. FIG. 5 is a conceptual diagram illustrating a change in color gamut when the first color gamut conversion lookup table of FIG. 4 is applied.

Referring to FIGS. 4 and 5, each of first color gamut conversion lookup tables LUT1 may include grid points (for example, a red point RP′, a green point GP′, a blue point BP′, a cyan point CP′, a magenta point MP′, a yellow point YP′, and a white point WP′ which define a converted color gamut.

A color gamut may be defined by a plurality of grid points. For example, a range of a color gamut may be defined by grid points including a black point KP, a red point RP or RP′, a green point GP or GP′, a blue point BP or BP′, a cyan point CP or CP′, a magenta point MP or MP′, a yellow point YP or YP′, and a white point WP or WP′. Coordinates of each grid point may consist of an RGB value.

Because the black point KP is fixed to an origin point (for example, (0, 0, 0)), the first color gamut conversion lookup table LUT1 may not include coordinates of the black point KP (that is, an RGB value). However, the present invention is not limited thereto, and if necessary, the first color gamut conversion lookup table LUT1 may include the coordinates of the black point KP.

In one or more embodiments, the grid points defining the converted color gamut may be determined by a target RGB value T_RGB (see FIG. 3). For example, in the first color gamut conversion lookup table LUT1 for 255-gradation 255G (see FIG. 3), when an RGB value MP_RGB (see FIG. 3) of a measurement pattern is (255, 0, 0), and a corresponding target RGB value T_RGB (see FIG. 3) is (235, 20, 20), coordinates of the red point RP′ may be (235, 20, 20). For example, in the first color gamut conversion lookup table LUT1 for 254-gradation 254G (see FIG. 3), the RGB value MP_RGB (see FIG. 3) of the measurement pattern is (254, 0, 0), and the corresponding target RGB value T_RGB (see FIG. 3) is (234, 20, 20), the coordinates of the red point RP′ may be determined by interpolating the target RGB value T_RGB (see FIG. 3) of (234, 20, 20). This is because the grid points are points for defining a color gamut and are points for the maximum gradation. However, the present disclosure is not limited to a method of determining coordinates of grid points from the target RGB value T_RGB (see FIG. 3).

In one or more embodiments, when a color gamut is converted, for a mixed color (that is, a color excluding black, white, red, green, blue, cyan, magenta, and/or yellow) or gradations excluding 255-gradation, an RGB value may be converted through tetrahedral interpolation. However, the present disclosure is not limited thereto.

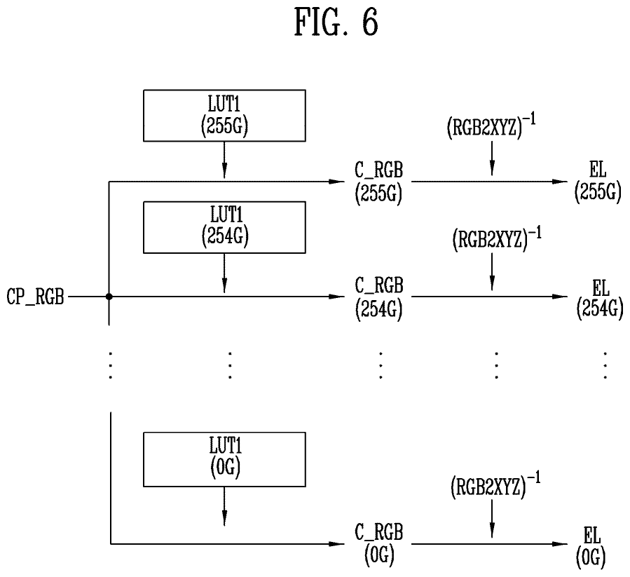

FIGS. 2-5 only illustrate an example of a method of generating the first color gamut conversion lookup table LUT1, and a second color gamut conversion lookup table described below with reference to FIGS. 6-13 does not necessarily have to be selected from the first color gamut conversion lookup tables LUT1 generated by the method of FIGS. 2-5. It is enough that the second color gamut conversion lookup table is selected from lookup tables for converting a color gamut.

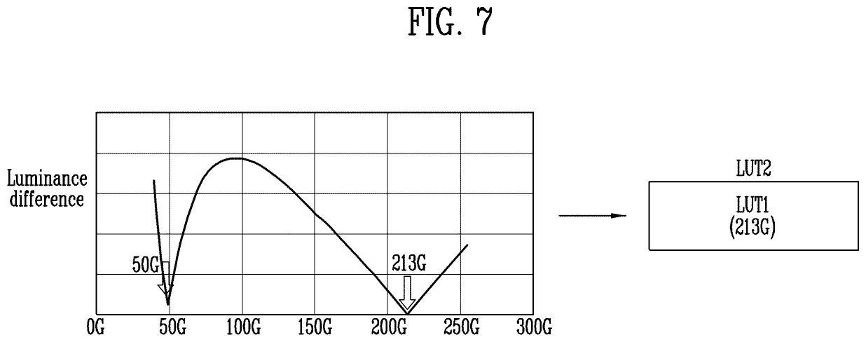

FIG. 6 is a conceptual diagram showing an example in which expected luminance according to the method of converting a color gamut of FIG. 1 is determined. FIG. 7 is a conceptual graph showing an example in which a second color gamut conversion lookup table according to the method of converting a color gamut of FIG. 1 is selected.

An x axis of the graph in FIG. 7 shows a gradation, and a y axis shows a difference between expected luminance and target luminance (hereinafter also referred to as a luminance difference).

Referring to FIG. 6, in the method of converting a color gamut, each of first color gamut conversion lookup tables LUT1 may be applied to an RGB value CP_RGB of a comparison pattern to generate a compensation RGB value C_RGB for each of the first color gamut conversion lookup tables LUT1.

In one or more embodiments, the comparison pattern may be different from the measurement pattern described above. By using the comparison pattern that is different from the measurement pattern, a display device using a second color gamut conversion lookup table may accurately display colors to be displayed in various patterns.

In one or more embodiments, the comparison pattern may include at least one of patterns of a Macbeth chart. However, the present disclosure is not limited to a type of the comparison pattern.

An RGB value MP_RGB of the measurement pattern is a value that is automatically determined when the measurement pattern is determined.

The RGB value CP_RGB of the comparison pattern is a value that is automatically determined when the comparison pattern is determined (e.g., the RGB value CP_RGB of the comparison pattern is a suitable value). The compensation RGB value C_RGB may be an RGB value that changes when a color gamut for the RGB value CP_RGB of the comparison pattern is converted by the first gamut conversion lookup table LUT1.

In the method of converting a color gamut, expected luminance EL according to the compensation RGB value C_RGB may be determined. For example, in the method of converting a color gamut, the compensation RGB value C_RGB may be converted into a tristimulus XYZ value using an RGB2XYZ conversion matrix (that is, using an inverse matrix of the RGB2XYZ conversion matrix), and the expected luminance EL may be determined from the tristimulus XYZ value for the compensation RGB value C_RGB. Because a Y value in the tristimulus XYZ value is a value indicating luminance, the expected luminance EL may be determined from the tristimulus XYZ value.

Referring to FIGS. 6 and 7, in the method of converting a color gamut, the expected luminance EL may be compared with the target luminance in the comparison pattern, and based on a comparison result, at least one of the first color gamut conversion lookup tables LUT1 may be selected as the second color gamut conversion lookup table LUT2.

The target luminance in the comparison pattern may be luminance desired to be displayed on a display panel when the comparison pattern is displayed on the display panel. That is, the target luminance may be preset. For example, the target luminance may be automatically determined (e.g., the target luminance may have a suitable value) when the comparison pattern is determined.

From among the first gamut conversion lookup tables LUT1, the lookup table with the smallest difference between the expected luminance EL and the target luminance may be selected as the second gamut conversion lookup table LUT2. For example, as shown in FIG. 7, a luminance difference may be the smallest when the first color gamut conversion lookup table LUT1 for 213-gradation 213G is applied. In this case, the first color gamut conversion lookup table LUT1 for 213-gradation 213G may be selected as the second color gamut conversion lookup table LUT2.

In one or more embodiments, when a plurality of measurement patterns are used, a luminance difference for each gradation may be an average or sum of luminance differences for each of measurement patterns. However, the present disclosure is not limited to a method of calculating a luminance difference for each gradation.

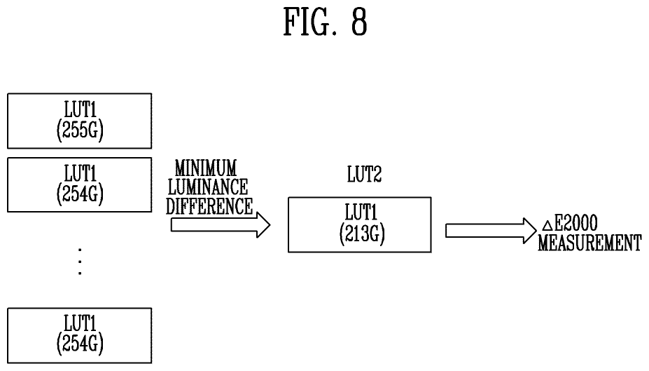

FIGS. 8 and 9 are diagrams showing color difference improvement according to the method of converting a color gamut of FIG. 1.

Referring to FIG. 8, as described above, in the method of converting a color gamut, first color gamut conversion lookup tables LUT1 for gradations, and the lookup table with the smallest luminance difference may be selected as a second color gamut conversion lookup table LUT2.

In FIGS. 8 and 9, it is assumed that the first color gamut conversion lookup table LUT1 for 213-gradation 213G is a lookup table with the smallest luminance difference, a white pattern WHITE, a red pattern RED, a green pattern GREEN, a cyan pattern CYAN, magenta pattern MAGENTA, and a yellow pattern YELLOW are used as measurement patterns, and patterns of a Macbeth chart are used as comparison patterns. For example, the patterns of the Macbeth chart may include a dark skin pattern DARK SKIN, a light skin pattern LIGHT SKIN, a blue sky pattern BLUE SKY, a foliage pattern FOLIAGE, a blue flower pattern BLUE FLOWER, a bluish green pattern BLUISH GREEN, an orange pattern ORANGE, a purplish blue pattern PURPLISH BLUE, a moderate red pattern MODERATE RED, a purple pattern PURPLE, a yellow green pattern YELLOW GREEN, an orange yellow pattern ORANGE YELLOW, a blue pattern BLUE_MAC, a green pattern GREEN_MAC, a red pattern RED_MAC, a yellow pattern YELLOW_MAC, a magenta pattern MAGENTA_MAC, a cyan pattern CYAN_MAC, a white 9.5 pattern WHITE_9.5, a natural 8 pattern NEUTRAL_8, a natural 6.5 pattern NEUTRAL_6.5, a natural 3.5 pattern NEUTRAL_3.5, and a black 2 pattern BLACK_2.

FIG. 9 shows a delta E2000 value for each pattern when the first color gamut conversion lookup table LUT1 for 213-gradation 213G, which is selected as the second color gamut conversion lookup table LUT2, is applied, and a delta E2000 value for each pattern when the first color gamut conversion lookup table LUT1 for 255-gradation 255G is applied.

Delta E2000 is a value that represents a color difference. As the Delta E2000 value becomes lower, a color to be displayed is accurately displayed.

As shown in FIG. 9, in a measurement pattern used to generate the first color gamut conversion lookup table LUT1, the delta E2000 value of the first color gamut conversion lookup table LUT1 for the 213-gradation 213G is similar to the delta E2000 value of the first color gamut conversion lookup table LUT1 for the 255-gradation 255G. However, in a comparison pattern that is not used to generate the first color gamut conversion lookup table LUT1, the delta E2000 value of the first color gamut conversion lookup table LUT1 for the 213-gradation 213G is lower than the delta E2000 value of the first color gamut conversion lookup for the 255-gradation 255G.

That is, in a pattern that is not used to generate the first color gamut conversion lookup table LUT1, the first color gamut conversion lookup table (that is, the first color gamut conversion lookup table LUT1 for the 213-gradation 213G) selected as the second color gamut conversion lookup table LUT2 may accurately display a color to be displayed as compared to the first gamut conversion lookup table LUT1 (for example, the first gamut conversion lookup table LUT1 for the 255-gradation 255G) that is not selected as the second gamut conversion lookup table LUT2.

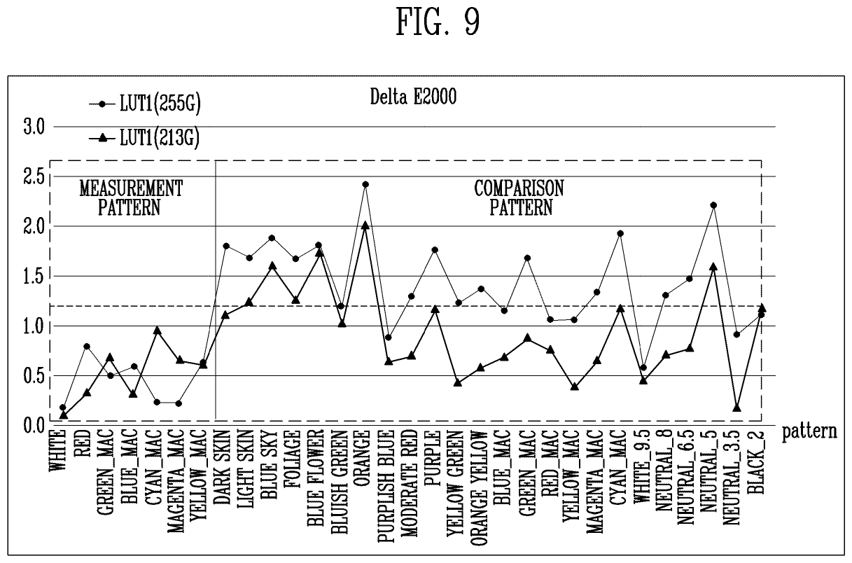

FIG. 10 is a block diagram illustrating a display device according to one or more embodiments of the present disclosure.

Referring to FIG. 10, the display device may include a display panel 100, a driving controller 200, a gate driver 300, a data driver 400, and a memory device 500. In one or more embodiments, the driving controller 200 and the data driver 400 may be integrated into one chip.

The display panel 100 may include a display area DA in which an image is displayed and a non-display area NDA disposed adjacent to the display area DA along an edge or a periphery of the display area DA. In one or more embodiments, the gate driver 300 may be mounted in the non-display area NDA.

The display panel 100 may include a plurality of gate lines GL, a plurality of data lines DL, and a plurality of pixels SP electrically connected to the gate lines GL and the data lines DL. The gate lines GL may extend in a first direction DR1, and the data lines DL may extend in a second direction DR2 that intersects the first direction DR1.

The driving controller 200 may receive input image data IMG and an input control signal CONT from a main processor (for example, a graphic processing unit GPU). For example, the input image data IMG may include red image data, green image data, and blue image data. In one or more embodiments, the input image data IMG may further include white image data. For another example, the input image data IMG may include magenta image data, yellow image data, and cyan image data. The input control signal CONT may include a master clock signal and a data enable signal. The input control signal CONT may further include a vertical synchronization signal and a horizontal synchronization signal.

The driving controller 200 may generate a first control signal CONT1, a second control signal CONT2, and a data signal DATA based on the input image data IMG, the input control signal CONT, and a second color gamut conversion lookup table LUT2.

The driving controller 200 may generate the first control signal CONT1 for controlling the operation of the gate driver 300 based on the input control signal CONT and output the first control signal CONT1 to the gate driver 300. The first control signal CONT1 may include a vertical start signal and a gate clock signal.

The driving controller 200 may generate the second control signal CONT2 for controlling the operation of the data driver 400 based on the input control signal CONT and output the second control signal CONT2 to the data driver 400. The second control signal CONT2 may include a horizontal start signal and a load signal.

The driving controller 200 may receive the second color gamut conversion lookup table LUT2, the input image data IMG, and the input control signal CONT and generate the data signal DATA. The driving controller 200 may output the data signal DATA to the data driver 400.

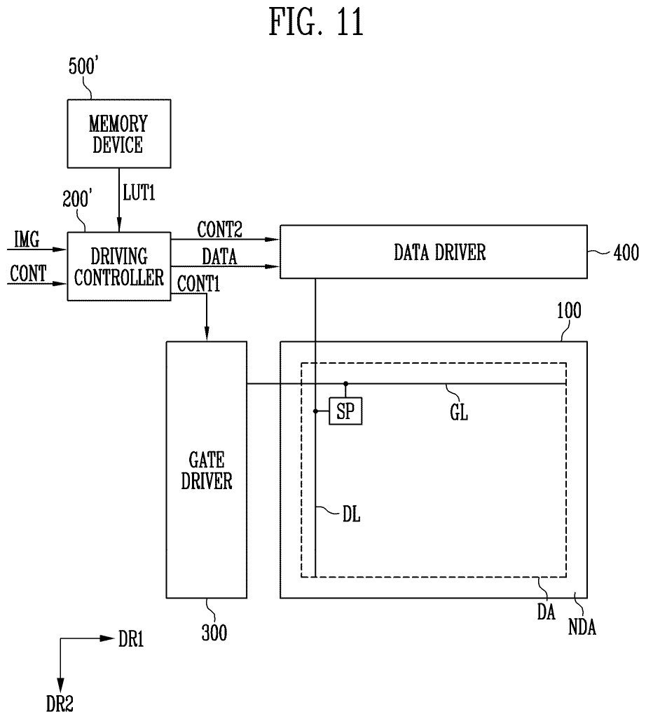

The driving controller 200 may convert a color gamut of an image displayed on the display panel 100 using the second color gamut conversion lookup table LUT2. For example, the driving controller 200 may convert the input image data IMG into compensation image data CIMG (see FIG. 12) using the second color gamut conversion lookup table LUT2. For example, the driving controller 200 may convert an input RGB value I_RGB (see FIG. 12) of the input image data IMG into an output RGB value O_RGB (see FIG. 12) to generate the compensation image data CIMG (see FIG. 12) and may generate the data signal DATA based on the compensation image data CIMG (see FIG. 12).

The gate driver 300 may generate gate signals for driving the gate lines GL in response to the first control signal CONT1 received from the drive controller 200. The gate driver 300 may output the gate signals to the gate lines GL. For example, the gate driver 300 may sequentially output the gate signals to the gate lines GL.

The data driver 400 may receive the second control signal CONT2 and the data signal DATA from the driving controller 200. The data driver 400 may generate data voltages by converting the data signal DATA into an analog voltage. The data driver 400 may output the data voltages to the data lines DL.

The memory device 500 may store the second color gamut conversion lookup table LUT2 and provide the second color gamut conversion lookup table LUT2 to the driving controller 200. That is, the memory device 500 may store the second color gamut conversion lookup table LUT2 selected according to the method of converting a color gamut described with reference to FIGS. 1-7. In this case, the second color gamut conversion lookup table LUT2 may be selected through a separate computing device rather than the display device. For example, the memory device 500 may be a non-volatile memory device.

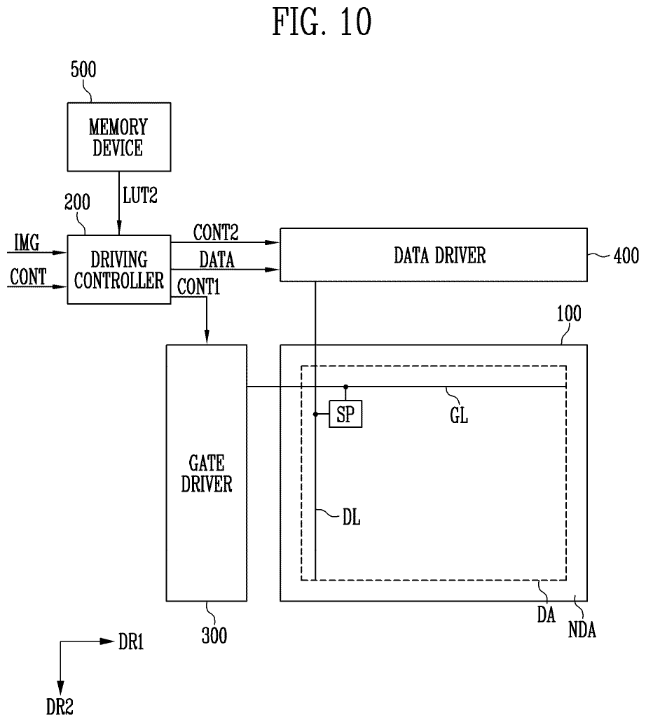

FIG. 11 is a block diagram illustrating a display device according to one or more embodiments of the present disclosure. FIG. 12 is a block diagram illustrating an example of a driving controller of FIG. 11.

Because the display device according to the present embodiments has substantially the same configuration as the display device of FIG. 10, except that a memory device 500′ stores a first color gamut conversion lookup tables LUT1 and a driving controller unit 200′ selects a second color gamut conversion lookup table LUT2, the same or similar components are assigned the same reference numbers and reference symbols, and redundant descriptions are omitted.

Referring to FIGS. 11 and 12, the memory device 500′ may store the first color gamut conversion lookup tables LUT1. The memory device 500′ may provide the first color gamut conversion lookup tables LUT1 to the driving controller 200′.

In one or more embodiments, when the driving controller 200′ selects the second color gamut conversion lookup table LUT2, the memory device 500′ may be left with only the first color gamut conversion lookup table LUT1 selected as the second color gamut conversion lookup table LUT2, and may delete the remaining first color gamut conversion lookup tables LUT1.

In one or more embodiments, the memory device 500′ may store the first color gamut conversion lookup tables LUT1 even after the second color gamut conversion lookup table LUT2 is selected. The driving controller 200′ may reselect the second color gamut conversion lookup table LUT2 periodically or according to a setting of a user. However, the present disclosure is not limited thereto, and the driving controller 200′ may reselect the second color gamut conversion lookup table LUT2 when the characteristics of a display panel 100 change.

The driving controller 200′ may include a lookup table selector 210 and a color gamut converter 220.

The lookup table selector 210 may receive the first color gamut conversion lookup tables LUT1 and may select at least one of the first color gamut conversion lookup tables LUT1 as the second color gamut conversion lookup table LUT2. The lookup table selector 210 may provide the second color gamut conversion lookup table LUT2 to the color gamut converter 220. That is, the lookup table selector 210 may perform operations S200, S300, S400, and S500 of FIG. 1.

The color gamut converter 220 may convert a color gamut of an image displayed on the display panel 100 using the second color gamut conversion lookup table LUT2. For example, the color gamut converter 220 may convert input image data IMG into compensation image data CIMG using the second color gamut conversion lookup table LUT2. For example, the color gamut converter 220 may generate the compensation image data CIMG by converting an input RGB value I_RGB of the input image data IMG into an output RGB value O_RGB.

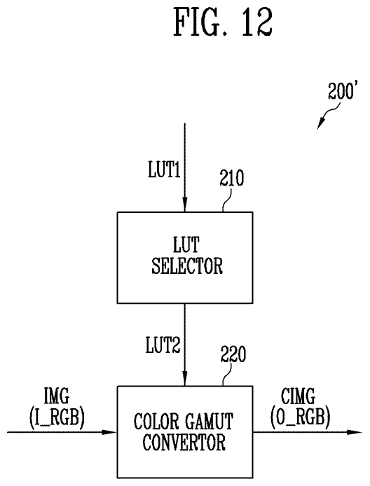

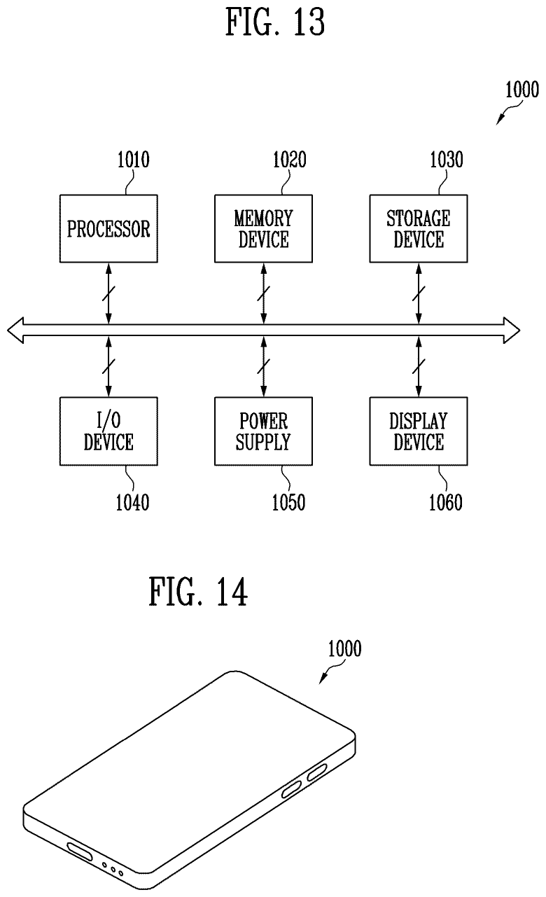

FIG. 13 is a block diagram illustrating an electronic device according to one or more embodiments of the present disclosure. FIG. 14 is a view illustrating an example in which the electronic device of FIG. 13 is implemented as a smartphone.

Referring to FIGS. 13 and 14, an electronic device 1000 may include a processor 1010, a memory device 1020, a storage device 1030, an input/output device 1040, a power supply device 1050, and a display device 1060. In this case, the display device 1060 may be the display device of FIG. 10 or FIG. 11. In addition, the electronic device 1000 may further include various ports that may communicate with a video card, a sound card, a memory card, a universal serial bus (USB) device, and/or the like, or may communicate with other systems. In one embodiment, as shown in FIG. 14, the electronic device 1000 may be implemented as the smartphone. However, this is merely an example, and the electronic device 1000 is not limited thereto. For example, the electronic device 1000 may be implemented as a mobile phone, a video phone, a smart pad, a smart watch, a tablet personnel computer (PC), a vehicle navigation device, a computer monitor, a laptop, a head mounted display device, and/or the like.

The processor 1010 may perform specific calculations or tasks. According to one or more embodiments, the processor 1010 may be a microprocessor, a central processing unit (CPU), an application processor, and/or the like. The processor 1010 may be connected to other components through an address bus, a control bus, and/or a data bus. According to one or more embodiments, the processor 1010 may also be connected to an expansion bus such as a peripheral component interconnect (PCI) bus.

The memory device 1020 may store data necessary for the operation of the electronic device 1000. For example, the memory device 1020 may include non-volatile memory devices such as an erasable programmable read-only memory (EPROM) device, an electrically erasable programmable read-only memory (EEPROM) device, a flash memory device, a phase change random access memory (PRAM) device, a resistance random access memory (RRAM) device, a nano-floating gate memory (NFGM) device, a polymer random access memory (PoRAM) device, a magnetic random access memory (MRAM) device, and/or a ferroelectric random access memory (FRAM) device, and/or volatile memory devices such as a dynamic random access memory (DRAM) device, a static random access Memory (SRAM) device, and/or a mobile DRAM device.

The storage device 1030 may include a solid state drive (SSD), a hard disk drive (HDD), a CD-ROM, and/or the like.

The input/output device 1040 may include an input means such as a keyboard, a keypad, a touchpad, a touch screen, and/or a mouse and an output means such as a speaker and/or a printer. According to one or more embodiments, the display device 1060 may be included in the input/output device 1040.

The power supply device 1050 may supply power necessary for the operation of the electronic device 1000. For example, the power supply device 1050 may be a power management integrated circuit (PMIC).

The display device 1060 may display an image corresponding to visual information of the electronic device 1000. In this case, the display device 1060 may be an organic light-emitting display device or a quantum dot light-emitting display device, but is not limited thereto. The display device 1060 may be connected to other components through the buses and/or other communication links.

Although embodiments and application examples are described herein, they are provided only for assisting in the entire understanding of the present disclosure.

Therefore, the present disclosure is not limited to the embodiments. Various modifications and changes may be made by those skilled in the art to which the present disclosure pertains from this description.
Therefore, the spirit of the present disclosure should not be limited to the above-described embodiments, and the following claims as well as all modified equally or equivalently to the claims are intended to fall within the scope and spirit of the present disclosure.

The present disclosure may be applied to a display device and an electronic device including the same. For example, the present disclosure may be applied to digital televisions (TVs), three-dimensional (3D) TVs, mobile phones, smartphones, tablet computers, virtual reality (VR) devices, PCs, home electronic devices, laptop computers, personal digital assistants (PDAs), portable media players (PMPs), digital cameras, music players, portable game consoles, navigation devices, and/or the like.

While the present disclosure has been described with reference to one or more embodiments, it will be understood by those skilled in the art that various changes and modifications may be made without departing from the spirit and scope of the present disclosure as defined by the appended claims and their equivalents.

What is claimed is:

1. A method of converting a color gamut, the method comprising:
generating first color gamut conversion lookup tables for gradations;
applying each of the first color gamut conversion lookup tables to a red-green-blue (RGB) value of a comparison pattern to generate a compensation RGB value for each of the first color gamut conversion lookup tables;
determining an expected luminance according to the compensation RGB value;
comparing the expected luminance with a target luminance in the comparison pattern;
selecting at least one of the first color gamut conversion lookup tables as a second color gamut conversion lookup table according to a comparison result; and
converting the color gamut of an image displayed on a display panel using the second color gamut conversion lookup table.

2. The method of claim 1, wherein a lookup table with a smallest difference between the expected luminance and the target luminance from among the first color gamut conversion lookup tables is selected as the second color gamut conversion lookup table.

3. The method of claim 1, wherein the comparison pattern comprises at least one of patterns of a Macbeth chart.

4. The method of claim 1, wherein the determining of the expected luminance comprises:
converting the compensation RGB value into a tristimulus XYZ value using an RGB2XYZ conversion matrix; and
determining the expected luminance from the tristimulus XYZ value for the compensation RGB value.

5. The method of claim 1, wherein the target luminance is preset.

6. The method of claim 1, wherein the generating of the first color gamut conversion lookup tables comprises:
converting target color coordinates of a measurement pattern for one gradation to a target RGB value using an RGB2XYZ conversion matrix; and
generating the first color gamut conversion lookup table for the one gradation by allowing the RGB value of the measurement pattern to correspond to the target RGB value.

7. The method of claim 6, wherein the comparison pattern is different from the measurement pattern.

8. The method of claim 6, wherein the generating of the first color gamut conversion lookup tables further comprises:
displaying a white pattern on the display panel; and
measuring color coordinates of the display panel,
wherein a reference white point of the RGB2XYZ conversion matrix is determined by the color coordinates of the display panel in the white pattern.

9. The method of claim 6, wherein the measurement pattern is at least one of a white pattern, a red pattern, a green pattern, a blue pattern, a cyan pattern, a magenta pattern, or a yellow pattern.

10. The method of claim 1, wherein each of the first color gamut conversion lookup tables comprises RGB values of grid points defining the converted color gamut.

11. A display device comprising:
a display panel comprising a pixel;
a data driver configured to provide a data voltage to the pixel; and
a driving controller configured to control the data driver,
wherein the driving controller is configured to:
apply each of first color gamut conversion lookup tables to an red-green-blue (RGB) value of a comparison pattern to generate a compensation RGB value for each of the first color gamut conversion lookup tables;
determine an expected luminance according to the compensation RGB value;
compare the expected luminance with a target luminance in the comparison pattern;
select at least one of the first color gamut conversion lookup tables as a second color gamut conversion lookup table according to a comparison result; and
convert a color gamut of an image displayed on the display panel using the second color gamut conversion lookup table.

12. The display device of claim 11, wherein the driving controller is configured to select a lookup table with a smallest difference between the expected luminance and the target luminance from among the first color gamut conversion lookup tables as the second color gamut conversion lookup table.

13. The display device of claim 11, wherein the comparison pattern comprises at least one of patterns of a Macbeth chart.

14. The display device of claim 11, wherein the driving controller is configured to convert the compensation RGB value into a tristimulus XYZ value using an RGB2XYZ conversion matrix and configured to determine the expected luminance from a tristimulus value for the compensation RGB value.

15. The display device of claim 11, wherein the target luminance is preset.

16. The display device of claim 11, further comprising a memory device configured to store the first color gamut conversion lookup tables.

17. The display device of claim 11, wherein each of the first color gamut conversion lookup tables comprises RGB values of grid points defining the converted color gamut.

18. An electronic device comprising:
a display panel comprising a pixel;
a data driver configured to provide a data voltage to the pixel;
a driving controller configured to control the data driver;
a processor configured to provide input image data to the driving controller, wherein the driving controller is configured to:
apply each of first color gamut conversion lookup tables to an red-green-blue (RGB) value of a comparison pattern to generate a compensation RGB value for each of the first color gamut conversion lookup tables;
determine an expected luminance according to the compensation RGB value;
compare the expected luminance with a target luminance in the comparison pattern;
select at least one of the first color gamut conversion lookup tables as a second color gamut conversion lookup table according to a comparison result; and
convert a color gamut of an image displayed on the display panel using the second color gamut conversion lookup table, wherein the target luminance is preset.

19. The electronic device of claim 18, wherein the electronic device comprises a digital television (TV), a three-dimensional (3D) TV, a mobile phone, a smartphone, a tablet computer, a virtual reality (VR) device, a home electronic device, a laptop computer, a personal digital assistant (PDA), a portable media player (PMP), a digital camera, a music player, a portable game console, or a navigation device.
